(19) United States
(12) Patent Application Publication
(10) Pub. No.: US 2002/0053462 A1
(43) Pub. Date: May 9, 2002

(54) Multiple twisted conductor

(75) Inventors: Joachim Runge, Bad Arolsen (DE); Hans-Joachim Krenzer, Bad Arolsen (DE); Leonard Danel, Neuflieux (FR)

Correspondence Address: SUGHRUE MION, PLLC, 2100 Pennsylvania Avenue, NW, Washington, DC, 20037-3213, US

(73) Assignee: NEXANS

(21) Appl. No.: 09/982,815

(22) Filed: Oct. 22, 2001

(30) Foreign Application Priority Data
Oct. 23, 2000 (EP) 00402923.7
Nov. 27, 2000 (EP) 00403312.2

(51) Int. Cl. H01B 5/08

(52) U.S. Cl. 174/128.1

(57) ABSTRACT

A multiple twisted conductor, which comprises at least two individual twisted conductors (1, 2) comprising individual enamel insulated partial conductors (3), and a common sheath (5) enclosing the individual twisted conductors (1, 2). The individual twisted conductors (1, 2) are arranged inside the common sheath (5) without any insulating layer of their own.

This application is based on and claims the benefit of European Patent Application No. 00402923.7 filed Oct. 23, 2000, and from European Patent Application No. 004013312.2 filed Nov. 27, 2000.

### BACKGROUND OF THE INVENTION

The invention relates to a multiple twisted conductor of the type comprising at least two individual twisted conductors of individual enamel insulated partial conductors, and a joint sheath surrounding the individual twisted conductors, and to a process for producing such a multiple twisted conductor.

In high current power transformers, several twisted conductors are wound axially parallel to limit the current density. Multiple twisted conductors comprising two or three individual twisted conductors with common insulation are also used. Such multiple twisted conductors have a plurality of twisted conductors, each consisting of two stacks of enamel-insulated partial conductors arranged side by side and having common insulation, which typically consists of a paper wrapping.

To produce such a multiple twisted conductor, a plurality of twisted conductors are first produced by Roebel transposition from a plurality of enamel-insulated partial conductors. Subsequently, the twisted conductor is wrapped with paper tape. Each twisted conductor is wound onto a separate drum. To produce the multiple twisted conductor, the necessary number of individual twisted conductors are guided in parallel through a wrapping unit in which the twisted conductors provided with their paper wrapping receive a common sheath in the form of a paper wrapping.

### SUMMARY OF THE INVENTION

An object of the present invention is to provide a multiple twisted conductor with reduced outside dimensions and a process for cost-effectively producing the multiple twisted conductor. In particular, the multiple twisted conductor is designed to reduce the losses of a transformer due to a better stacking factor.

This object is attained by a multiple twisted conductor comprising at least two individual twisted conductors of individual enamel insulated partial conductors, and a joint sheath surrounding the individual twisted conductors, wherein the individual twisted conductors are arranged inside the common sheath without any insulating layer of their own.

The object of the invention is further attained by a process for producing such a multiple twisted conductor wherein the individual conductors comprising the enamel-insulated partial conductors are pulled from at least one supply reel, joined, and provided with a common sheath, said process further comprising the step of providing the individual twisted conductors, which do not have any insulating layer of their own, with a common insulating sheath.

An essential advantage of the invention is that, compared to a conventional multiple twisted conductor, separate insulation of the individual twisted conductors is dispensed with. If necessary, a spacer is provided between the individual twisted conductors, which prevents mechanical damage to the enamel-insulated partial conductors during transport and processing. The thickness of said spacer should be less than twice the wall thickness of the conventionally used paper wrapping of the twisted conductors.

Only two process steps are required to produce the multiple twisted conductor. A length of an individual twisted conductor is produced without insulation and wound onto a coil. This twisted conductor, during twisting of a second twisted conductor, is fed jointly with the latter to a wrapping unit in which a joint paper wrapping is applied to the twisted conductors. This eliminates the separate preliminary production of the second twisted conductor.

### BRIEF DESCRIPTION OF THE DRAWINGS

The invention will now be described in greater detail, by way of example, with the aid of the embodiments schematically depicted in the accompanying drawings, wherein:

FIGS. 1a and 1b illustrate a cross-section through a prior art multiple twisted conductor;

FIGS. 2a, 2b and 2c show multiple twisted conductors according to the teaching of the invention; and

FIG. 3 is a schematic representation of the production process.

### DETAILED DESCRIPTION OF THE INVENTION

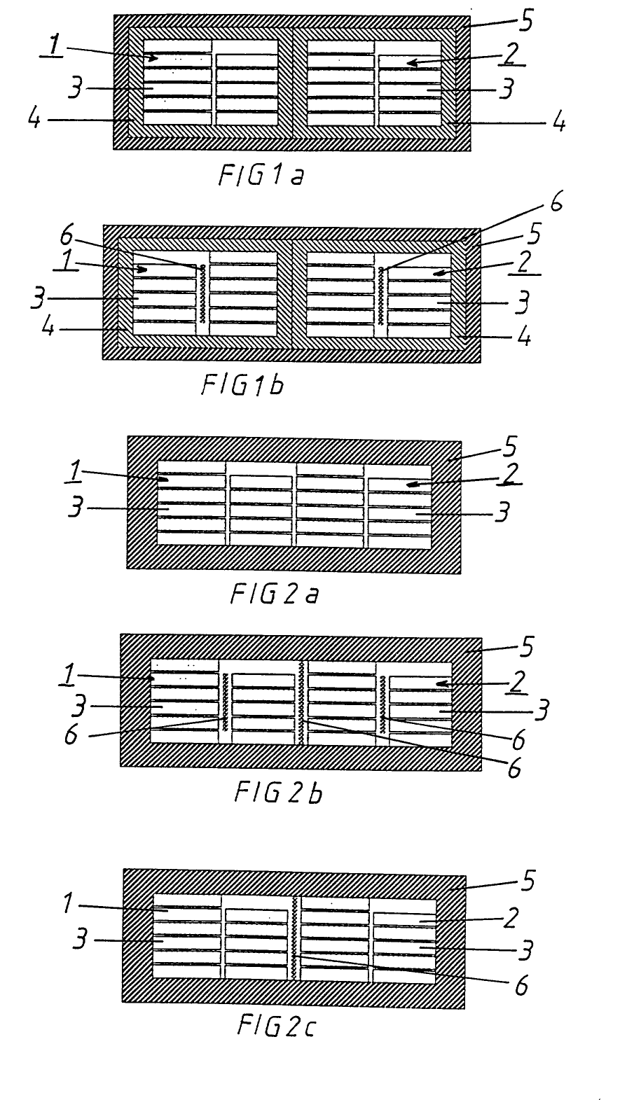

The multiple twisted conductors according to FIGS. 1a and 1b comprise two twisted conductors 1 and 2 arranged side by side, each of which consists of two stacks of enamel-insulated partial conductors 3, which are twisted together or Roebel transposed. Each twisted conductor 1, 2 is surrounded by a separate insulating layer 4, preferably a paper wrapping. The two twisted conductors 1, 2 are surrounded by a common insulating layer 5, preferably a paper wrapping. In the multiple twisted conductor shown in FIG. 1b, twisted conductors 1, 2 are mutually insulated by a spacer 6.

In the multiple twisted conductors according to the teaching of the invention, shown in FIGS. 2a, 2b and 2c, the two twisted conductors 1 and 2 are bare, i.e., only the partial conductors 3 are provided with thin enamel insulation. In the exemplary embodiment according to FIGS. 2b and 2c, to protect the enamel insulating layers on partial conductors 3 as the multiple twisted conductor is being produced, or as the transformer winding is being wound, a spacer 6, e.g., made of pressboard, is provided between the two twisted conductors 1 and 2. A sheath 5, preferably a paper wrapping, surrounds the twisted conductors 1 and 2. The wall thickness of the sheath depends on the transformer manufacturer's requirements. As a rule, the wall thickness is equal to the sum of the wall thicknesses of insulating layer 4 and insulating layer 5 of the multiple twisted conductor shown in FIG. 1.

In the embodiment depicted in FIG. 2b, separate spacers 6 are additionally provided between the partial conductor stacks.

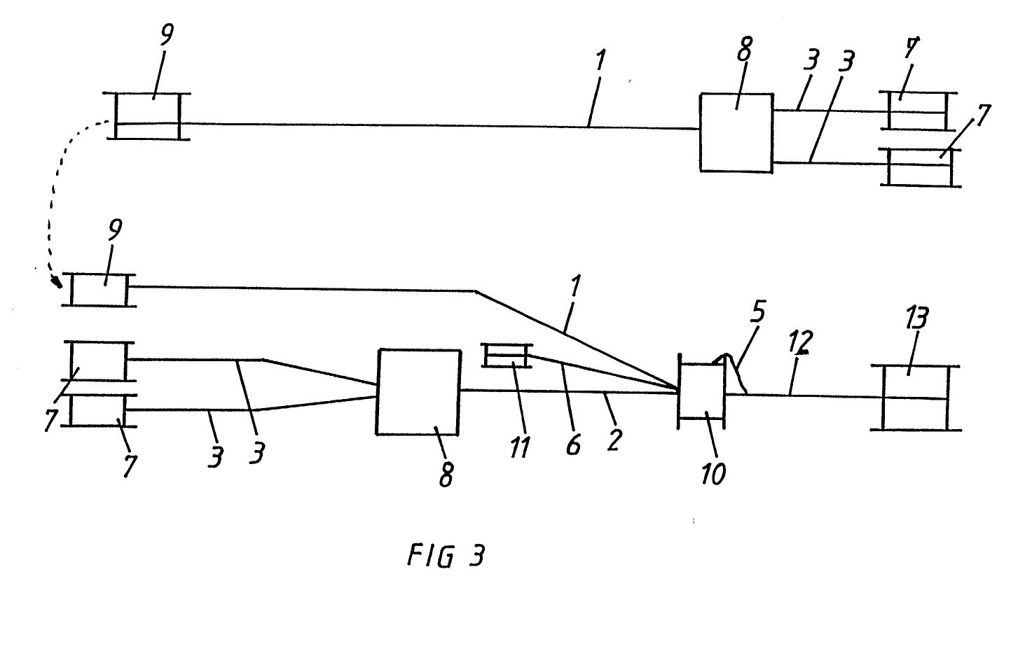

A schematic diagram of the production sequence is shown in FIG. 3. First, in a Roebel unit 8, a first twisted conductor 1 is produced by Roebel transposition from a plurality of partial conductors 3, which are pulled from reels 7—only two of which are shown here for clarity's sake—and is wound onto a drum 9. Reel 9 with the twisted conductor 1 is integrated into the production line of a second twisted conductor 2. In this production line, a twisted conductor is produced as described above by pulling partial conductors 3—of which again only two are depicted—from supply reels 7 and by Roebel transposition in a Roebel unit 8. The two twisted conductors 1 and 2 are joined in front of a winding unit 10. A spacer 6 made of pressboard and pulled from a reel 11 is supplied between them. In winding unit 10, a wrapping 5 of several layers of paper tape is wrapped onto the two twisted conductors 1 and 2 as a joint sheath. The finished multiple twisted conductor 12 is wound onto a transport reel 13 to be delivered to the transformer manufacturer. What is claimed is

1. A multiple twisted conductor comprising at least two individual twisted conductors (1, 2) comprising individual enamel insulated partial conductors (3) and a joint sheath (5) surrounding the individual twisted conductors (1, 2), wherein the individual twisted conductors (1, 2) are arranged inside the common sheath (5) without any insulating layer of their own.

2. A multiple twisted conductor as claimed in claim 1, wherein the individual twisted conductors (1, 2) are spaced apart from one another by spacers (6) made of an insulating material.

3. A multiple twisted conductor as claimed in claim 2, wherein the spacer (6) is made of pressboard.

4. A process for producing a multiple twisted conductor in which at least two individual conductors comprising enamel insulated partial conductors are pulled from at least one supply reel, joined, and provided with a common sheath, said process further comprising the step of providing the individual twisted conductors, which do not have any insulating layer of their own, with a common insulating sheath.

5. A process as claimed in claim 4, wherein a spacer is arranged between the individual twisted conductors.

6. A process as claimed in claim 5, wherein a spacer made of pressboard is used.

7. A process as claimed in claim 4, wherein a first twisted conductor is produced from a plurality of partial conductors by Roebel transposition, and in the production line of the second twisted conductor, said first twisted conductor together with the second twisted conductor is provided with a common insulating sheath.
